(19) United States
(12) Patent Application Publication
(10) Pub. No.: US 2013/0094411 A1
(43) Pub. Date: Apr. 18, 2013

(54) METHODS AND SYSTEMS FOR CSI-RS TRANSMISSION IN LTE-ADVANCE SYSTEMS

(71) Applicant: Wenfeng Zhang, Plano, TX (US)

(72) Inventor: Wenfeng Zhang, Plano, TX (US)

(73) Assignee: ZTE CORPORATION, Shenzhen, Guangdong (CN)

(21) Appl. No.: 13/578,767

(22) PCT Filed: Feb. 17, 2011
(86) PCT No.: PCT/US2011/025272

§ 371 Date: Dec. 27, 2012

Related U.S. Application Data
(60) Provisional application No. 61/305,512, filed on Feb. 17, 2010.

(51) Int. Cl. H04W 72/04

(52) U.S. Cl. CPC H04W 72/04
USPC 370/281; 370/330

(57) ABSTRACT

A method of allocating resource elements in an orthogonal frequency division multiplexing (OFDM) system for transmission of a channel state information reference signal (CSI-RS) is disclosed. The method includes converting resource elements to a two-dimensional frequency-time domain. The converted resource elements can then be partitioned to units of a physical resource block (PRB), which can be one subframe, for example. It can be determined whether a portion of a PRB is being used by another signal; and if the portion of the PRB is not being used, it can be allocated for transmission of the CSI-RS. The CSI-RS can be transmitted at resource element locations determined by the resource elements available to the CSI-RS in a regular or a frequency-division duplexing (FDD) downlink subframe, for example. The CSI-RS can be transmitted in a downlink subframe configured as a Multi-Media Broadcast over a Single Frequency Network (MBSFN) or a non-MBSFN subframe.

### CROSS-REFERENCE TO RELATED APPLICATIONS

This application claims priority to U.S. Provisional Patent Application No. 61/305,512 filed on Feb. 17, 2010, entitled “Methods and Systems for CSI-RS Transmission in LTE-Advance Systems,” the content of which is incorporated by reference herein in its entirety.

### FIELD OF THE INVENTION

The present invention relates generally to wireless communication, and more particularly to methods of transmitting a channel state information reference signal (CSI-RS) in a wireless communication system.

### BACKGROUND

In wireless communication systems, downlink reference signals are normally created to provide reference for channel estimation used in coherent demodulation as well as a reference for a channel quality measurement used in multi-user scheduling. In the LTE Rel-8 specification, one single type of downlink reference format called a cell-specific reference signal (CRS) is defined for both channel estimation and channel quality measurement. The characteristics of Rel-8 CRS include that, regardless of multiple in, multiple out (MIMO) channel rank that the user equipment (UE) actually needs, the base station can always broadcast the CRS to all UE based on the largest number of MIMO layers/ports.

In the 3GPP LTE Rel-8 system, the transmission time is partitioned into units of a frame that is 10 ms long and is further equally divided into 10 subframes, which are labeled as subframe #0 to subframe #9. While the LTE frequency division duplexing (FDD) system has 10 contiguous downlink subframes and 10 contiguous uplink subframes in each frame, the LTE time-division duplexing (TDD) system has multiple downlink-uplink allocations, whose downlink and uplink subframe assignments are given in Table 1, where the letters D, U and S represent the corresponding subframes and refer respectively to the downlink subframe, uplink subframe and special subframe that contains the downlink transmission in the first part of a subframe and the uplink transmission in the last part of subframe.

TABLE 1
TDD allocation configurations

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In one system configuration instance (called normal cyclic prefix, or normal-CP) in LTE, each subframe includes 14 equal-duration time symbols with the index from 0 to 13. The frequency domain resource, up to the full bandwidth within one time symbol, is partitioned into subcarriers. One physical resource block (PRB) is defined over a rectangular 2-D frequency-time resource area, covering 12 contiguous subcarriers over the frequency domain and 1 subframe over the time domain, and holding 12*14=168 resource elements (RE), as shown in FIG. 2, for example.

Each regular subframe is partitioned into two parts: the PDCCH (physical downlink control channel) region and the PDSCH (physical downlink shared channel) region. The PDCCH region normally occupies the first several symbols per subframe and carries the handset specific control channels, and the PDSCH region occupies the rest of the subframe and carries the general-purpose traffic. The LTE system requires the following downlink transmissions to be mandatory:

Primary synchronization signal (PSS) and secondary synchronization signal (SSS): These two signals repeat in every frame and serve for the initial synchronization and cell identification detection after UE powers up. The transmission of PSS occurs at symbol #6 in subframes {0,5} for FDD systems with normal-CP, and at symbol #2 in subframes {1,6} for TDD systems; the transmission of SSS occurs at symbol #5 in subframes {0,5} for FDD with normal-CP, and at symbol #13 in subframes {0,5} for TDD with normal-CP.

Physical broadcast channel (PBCH): PBCH also repeats in every frame, and serves for broadcasting of essential cell information. Its transmission occurs over 4 symbols {7˜10} in subframe #0.

Cell-specific reference signal (CRS): CRS serves for downlink signal strength measurement, and for coherent demodulation of PDSCH in the same resource block. Sometimes it is also used for verification of cell identification done on PSS and SSS. CRS transmission has the same pattern in each regular subframe, and occurs on symbols {0,1,4,7,8,11} with a maximum of four transmission antenna ports in a normal-CP subframe. Each CRS symbol carries two CRS subcarriers per port per resource block dimension in frequency domain, as shown in FIG. 2.

System information block (SIB): SIB is the broadcast information that is not transmitted over PBCH. It is carried in a specific PDSCH that is decoded by every handset. There are multiple types of SIB in LTE, most of which have a configurably longer transmission cycle, except SIB type-1 (SIB1). SIB1 is fix-scheduled at subframe #5 in every even frame. SIB is transmitted in PDSCH identified by a system information radio network temporary identifier (SI-RNTI) given in the corresponding PDCCH.

Paging channel (PCH): The paging channel is used to address the handset in idle mode or to inform the handset of a system-wide event, such as the modification of content in SIB. In LTE Rel-8, PCH can be sent in any subframe from a configuration-selective set from {9}, {4,9} and {0,4,5,9} for FDD and {0}, {0,5}, {0,1,5,6} for TDD. PCH is transmitted in PDSCH identified by the paging RNTI (P-RNTI) given in the corresponding PDCCH.

Note that PSS/SSS/PBCH are transmitted within the six central PRBs in frequency domain, while SIB and PCH could be transmitted at any portion within the whole frequency bandwidth, which is at least six PRBs.

Besides the regular subframe as shown in FIG. 2, LTE systems also define one special subframe type—Multi-Media Broadcast over a Single Frequency Network (MBSFN) subframe. This type of subframe is defined to exclude regular data traffic and CRS from the PDSCH region. In other words, this type of subframe can be used by a base station, for example, to identify a zero-transmission region so that the handset would not try to search for the CRS within this region. The downlink subframes {1,2,3,6,7,8} in FDD and the downlink subframes {3,4,7,8,9} in TDD can be configured as an MBSFN subframe. In this disclosure, there subframes are termed MBSFN-capable subframes, while the rest of downlink subframes may be referred to as non-MBSFN-capable subframes. Note that most of the essential downlink signals and channels discussed above (e.g., PSS/SSS, PBCH, SIB and PCH) are transmitted in non-MBSFN-capable subframes.

As 3GPP LTE evolves from Rel-8 to Rel-10 (also called LTE-advance or LTE-A), due to the large number of supported antenna ports (up to 8), it can cost a large amount of overhead to maintain the CRS-like reference signal on all ports. It is agreed to separate downlink reference signal roles to the following different RS signaling:

Demodulation reference signal (DMRS): this type of RS is used for coherent channel estimation and should have sufficient density and should be sent on per UE basis.

Channel state information reference signal (CSI-RS): this type of RS is used for channel quality measurement by all UE and could be implemented over the frequency-time domain.

It is agreed in the 3GPP standard body that: DMRS patterns in each PRB is determined to be located at 24 REs as shown in FIG. 2; CSI-RS RE can not be allocated to symbols carrying PDCCH and Rel-8 CRS (i.e., CSI-RS cannot be allocated to REs on the symbols labeled as “CRS RE on antenna port k” and “Data RE on CRS symbol” in FIG. 2); the CSI-RS can only be inserted in resource elements which will not be interpreted by Rel-8 UEs as PSS/SSS or PBCH; the same CSI-RS pattern is desired between a non-MBSFN subframe and an MBSFN subframe. In other words, the CSI-RS pattern is designed based on the available resources in a non-MBSFN subframe; CSI-RS transmission cycles per cell is an integer multiple of 5 ms, and per-cycle transmission of CSI-RS RE for all ports per cell is performed within a single subframe; and N_{ANT} is denoted as the number of CSI-RS antenna ports per cell. The average density of CSI-RS is one RE per antenna port per PRB for N_{ANT} ∈ {2,4,8}.

Based on these agreements, this disclosure provides further principles and methods to allocate CSI-RS signals, among other features that will become apparent in light of the following description. These and other implementations and examples of the cell identification methods in software and hardware are described in greater detail in the attached drawings and detailed description.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One embodiment is directed to a method of allocating resource elements in an orthogonal frequency division multiplexing (OFDM) system for transmission of a CSI-RS. The method includes converting one or more resource elements to a two-dimensional frequency-time domain. The one or more converted resource elements can then be partitioned to units of a physical resource block (PRB), which can be one subframe for example. It can be determined whether at least a portion of a PRB is being used by another signal; and if the at least a portion of the PRB is not concurrently being used, it can be allocated for transmission of the CSI-RS.

The CSI-RS can be transmitted at resource element locations determined by the resource elements available to the CSI-RS in a regular or a FDD downlink subframe, for example. The CSI-RS can be transmitted in a downlink subframe configured as an MBSFN or a non-MBSFN subframe.

Another embodiment is directed to a station configured for allocating resource elements in an OFDM system for transmission of a CSI-RS. The station includes a conversion unit configured to convert one or more resource elements to a two-dimensional frequency-time domain. The station further includes a partitioning unit configured to partition the one or more converted resource elements to units of a PRB; a determination unit configured to determine whether at least a portion of a PRB is being used by a signal; and an allocation unit configured to allocate the at least a portion of the PRB for transmission of the CSI-RS, if the at least a portion of the PRB is not concurrently being used. According to certain embodiments, the station is a base station; however, one of ordinary skill in the art would realize that any station within a wireless communication system could include the foregoing functionality.

Yet another embodiment is directed to a non-transitory computer-readable recording medium storing thereon instructions for, when executed by a processor, performing a method of allocating resource elements in an OFDM system for transmission of a CSI-RS. The method includes converting one or more resource elements to a two-dimensional frequency-time domain. The one or more converted resource elements can then be partitioned to units of a physical resource block (PRB), which can be one subframe for example. It can be determined whether at least a portion of a PRB is being used by another signal; and if the at least a portion of the PRB is not concurrently being used, it can be allocated for transmission of the CSI-RS.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 shows an exemplary wireless communication system for transmitting and receiving transmissions, according to an embodiment.

FIG. 2 depicts a physical resource block with CRS and DMRS, according to an embodiment.

FIG. 3 depicts a physical resource block in subframe #0 with CRS, PSS/SSS and PBCH in FDD, according to an embodiment.

FIG. 4 depicts a physical resource block in subframe #0 with CRS, SSS and PBCH in TDD, according to an embodiment.

FIG. 5 depicts examples of a CSI-RS RE group with various shapes and sizes for, according to an embodiment.

FIG. 6 depicts a physical resource block with CRS and DMRS for N=3, according to an embodiment.

FIG. 7 depicts a physical resource block in subframe #0 with CRS, PSS/SSS and PBCH in FDD for N=3, according to an embodiment.

FIGS. 8A and 8B show exemplary options for allocation of physical resource blocks with CRS and DMRS for N=6, according to an embodiment.

FIGS. 9A and 9B show exemplary options for allocation of physical resource blocks in subframe #0 with CRS, PSS/SSS and PBCH in FDD for N=6, according to an embodiment.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

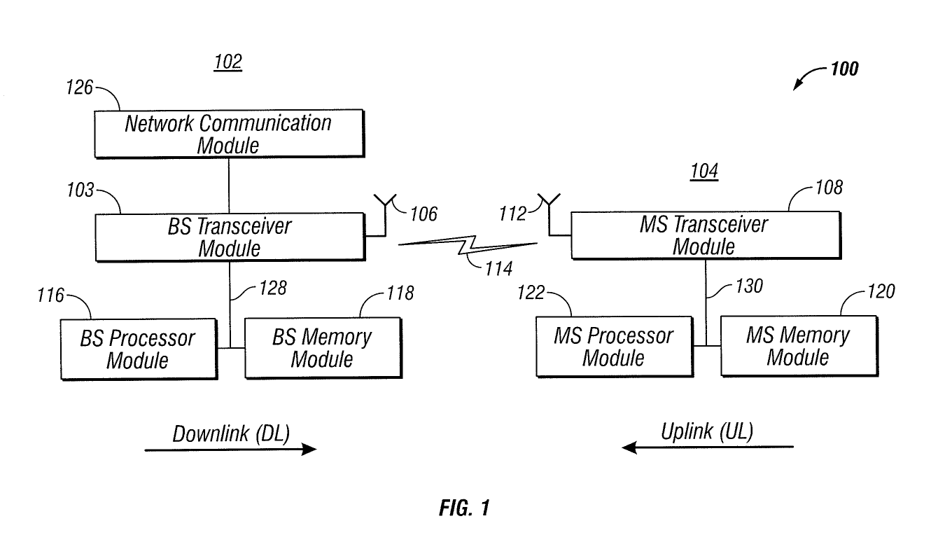

FIG. 1 shows an exemplary wireless communication system 100 for transmitting and receiving transmissions, in accordance with one embodiment of the present disclosure. The system 100 may include components and elements configured to support known or conventional operating features that need not be described in detail herein. System 100 generally comprises a base station 102 with a base station transceiver module 103, a base station antenna 106, a base station processor module 116 and a base station memory module 118. System 100 generally comprises a mobile station 104 with a mobile station transceiver module 108, a mobile station antenna 112, a mobile station memory module 120, a mobile station processor module 122, and a network communication module 126. Of course both base station 102 and mobile station 104 may include additional or alternative modules without departing from the scope of the present invention. Further, only one base station 102 and one mobile station 104 is shown in the exemplary system 100; however, any number of base stations 102 and mobile stations 104 could be included.

These and other elements of system 100 may be interconnected together using a data communication bus (e.g., 128, 130), or any suitable interconnection arrangement. Such interconnection facilitates communication between the various elements of wireless system 100. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary system 100, the base station transceiver 103 and the mobile station transceiver 108 each comprise a transmitter module and a receiver module (not shown). Additionally, although not shown in this figure, those skilled in the art will recognize that a transmitter may transmit to more than one receiver, and that multiple transmitters may transmit to the same receiver. In a TDD system, transmit and receive timing gaps exist as guard bands to protect against transitions from transmit to receive and vice versa.

In the particular example system depicted in FIG. 1, an “uplink” transceiver 108 includes a transmitter that shares an antenna with an uplink receiver. A duplex switch may alternatively couple the uplink transmitter or receiver to the uplink antenna in time duplex fashion. Similarly, a “downlink” transceiver 103 includes a receiver which shares a downlink antenna with a downlink transmitter. A downlink duplex switch may alternatively couple the downlink transmitter or receiver to the downlink antenna in time duplex fashion.

The mobile station transceiver 108 and the base station transceiver 103 are configured to communicate via a wireless data communication link 114. The mobile station transceiver 108 and the base station transceiver 102 cooperate with a suitably configured RF antenna arrangement 106/112 that can support a particular wireless communication protocol and modulation scheme. In the exemplary embodiment, the mobile station transceiver 108 and the base station transceiver 102 are configured to support industry standards such as the Third Generation Partnership Project Long Term Evolution (3GPP LTE), Third Generation Partnership Project 2 Ultra Mobile Broadband (3Gpp2 UMB), Time Division-Synchronous Code Division Multiple Access (TD-SCDMA), and Wireless Interoperability for Microwave Access (WiMAX), and the like. The mobile station transceiver 108 and the base station transceiver 102 may be configured to support alternate, or additional, wireless data communication protocols, including future variations of IEEE 802.16, such as 802.16e, 802.16m, and so on.

According to certain embodiments, the base station 102 controls the radio resource allocations and assignments, and the mobile station 104 is configured to decode and interpret the allocation protocol. For example, such embodiments may be employed in systems where multiple mobile stations 104 share the same radio channel which is controlled by one base station 102. However, in alternative embodiments, the mobile station 104 controls allocation of radio resources for a particular link, and could implement the role of radio resource controller or allocator, as described herein.

Processor modules 116/122 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 116/122 comprise processing logic that is configured to carry out the functions, techniques, and processing tasks associated with the operation of system 100. In particular, the processing logic is configured to support the frame structure parameters described herein. In practical embodiments the processing logic may be resident in the base station and/or may be part of a network architecture that communicates with the base station transceiver 103.

The steps of a method or algorithm described in connection with the embodiments disclosed herein may be embodied directly in hardware, in firmware, in a software module executed by processor modules 116/122, or in any practical combination thereof. A software module may reside in memory modules 118/120, which may be realized as RAM memory, flash memory, ROM memory, EPROM memory, EEPROM memory, registers, a hard disk, a removable disk, a CD-ROM, or any other form of storage medium known in the art. In this regard, memory modules 118/120 may be coupled to the processor modules 118/122 respectively such that the processors modules 116/120 can read information from, and write information to, memory modules 118/120. As an example, processor module 116, and memory modules 118, processor module 122, and memory module 120 may reside in their respective ASICs. The memory modules 118/120 may also be integrated into the processor modules 116/120. In an embodiment, the memory module 118/220 may include a cache memory for storing temporary variables or other intermediate information during execution of instructions to be executed by processor modules 116/222. Memory modules 118/120 may also include non-volatile memory for storing instructions to be executed by the processor modules 116/120.

Memory modules 118/120 may include a frame structure database (not shown) in accordance with an exemplary embodiment of the invention. Frame structure parameter databases may be configured to store, maintain, and provide data as needed to support the functionality of system 100 in the manner described below. Moreover, a frame structure database may be a local database coupled to the processors 116/122, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 126 generally represents the hardware, software, firmware, processing logic, and/or other components of system 100 that enable bi-directional communication between base station transceiver 103, and network components to which the base station transceiver 103 is connected. For example, network communication module 126 may be configured to support internet or WiMAX traffic. In a typical deployment, without limitation, network communication module 126 provides an 802.3 Ethernet interface such that base station transceiver 103 can communicate with a conventional Ethernet based computer network. In this manner, the network communication module 126 may include a physical interface for connection to the computer network (e.g., Mobile Switching Center (MSC)).

Note that the functions described in the present disclosure may be performed by either a base station 102 or a mobile station 104. A mobile station 104 may be any user device such as a mobile phone, and a mobile station may also be referred to as UE.

Embodiments disclosed herein have specific application but not limited to the Long Term Evolution (LTE) system that is one of the candidates for the 4-th generation wireless system. According to one embodiment, for 3GPP LTE-A, for example, a CSI-RS can be carried by one or more CRS-free symbols in the non-PDCCH region of a normal or MBSFN subframe. In certain embodiments, the CSI-RS may not be inserted in resource elements (REs) which are already occupied by Rel-8 PSS/SSS or PBCH. It is also possible to prevent the CSI-RS from interfering with the SIB1 that is sent in subframe #5, for example, and a PCH that can be sent in any subframe from a configured subset or full set of all non-MBSFN-capability subframes, according to exemplary embodiments. Accordingly, one of ordinary skill in the art would realize that there can be several options for the locations available for CSI-RS transmission. Below are various exemplary options:

### Exemplary Option-a:

According to one embodiment, a CSI-RS can be transmitted in a downlink subframe configured as an MBSFN subframe, such that CSI-RS is not transmitted in subframes {0,4,5,9}, for example, for FDD and subframes {0,1,5,6} for TDD. According to this embodiment, there may be more available REs per PRB, thus providing a larger CSI-RS reuse factor. The CSI-RS can be collision-free from essential system signals and common control channels.

However, the MBSFN subframe can keep a large percentage of system resources unavailable to Rel-8 PDSCH. There could be a limited number or even no subframes that can be configured as an MBSFN subframe for CSI-RS transmission in certain TDD uplink-downlink allocations (e.g., TDD allocation #0).

### Exemplary Option-b:

According to one embodiment, a CSI-RS may not be transmitted in subframes {0,4,5,9} for FDD and subframes {0,1,5,6} for TDD; but Exemplary Option-b allows CSI-RS to be sent in a downlink subframe that is MBSFN-capable but is not configured as an MBSFN subframe.

Accordingly, a system-wide resource pool for Rel-8 PDSCH is not affected. The CSI-RS is collision-free from essential system signals and common control channels. However, with subframes {0,1,5,6} excluded, there could be a limited number or even no downlink subframes available for CSI-RS transmission in certain TDD uplink-downlink allocations (e.g., TDD allocation #0).

Exemplary Option-c:

According to one embodiment, a CSI-RS can be transmitted in any downlink subframe in FDD and TDD; and in case of collision with an RE used by PSS/SSS/PBCH/SIB1/paging, a CSI-RS on that RE is not transmitted or its resource allocation avoids PSS/SSS/PBCH/SIB1/paging altogether. That is, the RE can be reallocated to another resource that is not used by PSS/SSS/PBCH/SIB1/paging.

According to this embodiment, CSI-RS transmission is feasible in all TDD allocations. However, a CSI-RS can be lost if there is a collision with PSS/SSS/PBCH/paging. In case of a CSI-RS cycle equal to 10 ms, such CSI-RS loss could be periodic or even constant for a CSI-RS within six central PRBs, for example. Note that the collision with PSS/SSS can be avoided if CSI-RS is not transmitted in the symbols that can carry Rel-10 DMRS, for example.

The UE may need to search for and decode PDCCH with SI-RNTI or P-RNTI to determine the resource allocated for SIB1 and PCH before measuring the intra-cell CSI-RS in corresponding subframes. However, it can be difficult for UE to know the collision situation between the CSI-RS and SIB1/PCH in the neighboring cells if the UE needs to measure inter-cell CSI-RS, for example.

### Exemplary Option-d:

According to one embodiment, a CSI-RS can be transmitted in any subframe in FDD and TDD, except the subframes transmitting SIB1 and PCH; and in case of collision with an RE used by PSS/SSS/PBCH, the CSI-RS on that RE may not be transmitted or its resource allocation can avoid PSS/SSS/PBCH all together. That is, the RE can be reallocated to another resource that is not used by PSS/SSS/PBCH.

According to this embodiment, compared to Exemplary Option-c, Exemplary Option-d makes it possible for the UE to measure a CSI-RS in the neighboring cells. However, the UE still may need to know a paging occasion (PO) configuration in the neighboring cell to avoid measuring a non-existing inter-cell CSI-RS in the subframe carrying PCH in the neighboring cell.

Depending on design characteristics, among the four exemplary options above, Option-b and Option-d may be better choice for FDD, while Option-d may be a better choice for TDD.

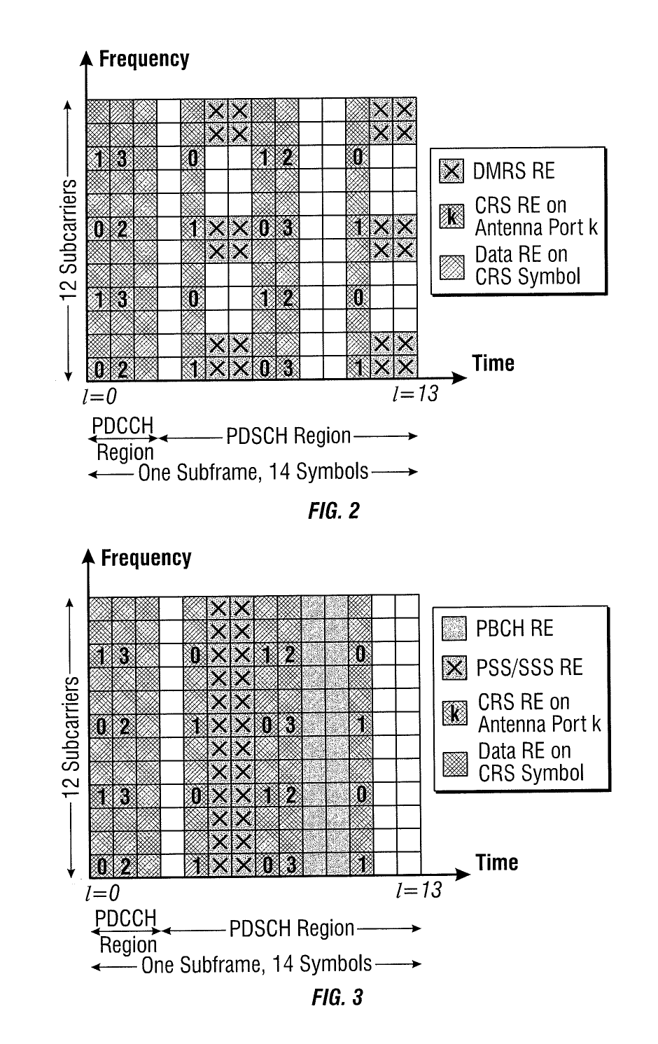

In Option-b, for example, the CSI-RS can be transmitted in downlink MBSFN-capable subframes {1,2,3,6,7,8} for FDD, and downlink MBSFN-capable subframes {3,4,7,8,9} for TDD. Within these subframes, the resources available in each PRB for the CSI-RS transmission is shown by an empty RE in FIG. 2, and counts to Z=60 REs per PRB if the CSI-RS and DMRS can be sent in the same symbol or Z=36 REs per PRB if CSI-RS and DMRS can not be sent in the same symbol, according to this embodiment.

In Option-d, for example, any MBSFN-capable downlink subframe in both FDD and TDD can be used for CSI-RS transmission, no matter whether any of these subframes is configured as a MBSFN subframe or not. For these subframes, the number of REs per PRB available to CSI-RS transmission can be the same as in Option-b (see FIG. 2) and given by Z=60 or Z=36 depending on whether the CSI-RS and DMRS can be put in the same symbol. As for the non-MBSFN-capable subframes, exemplary possible collisions between the CSI-RS and PSS/SSS/PBCH are summarized as below:

The potential collision with PSS/SSS/PBCH in FDD can happen in the six central PRBs in subframe #0 as shown in FIG. 3, for example. FIG. 3 depicts a physical resource block in subframe #0 with CRS, PSS/SSS and PBCH in FDD, according to an embodiment. There can be Z=36 REs available for CSI-RS transmission.

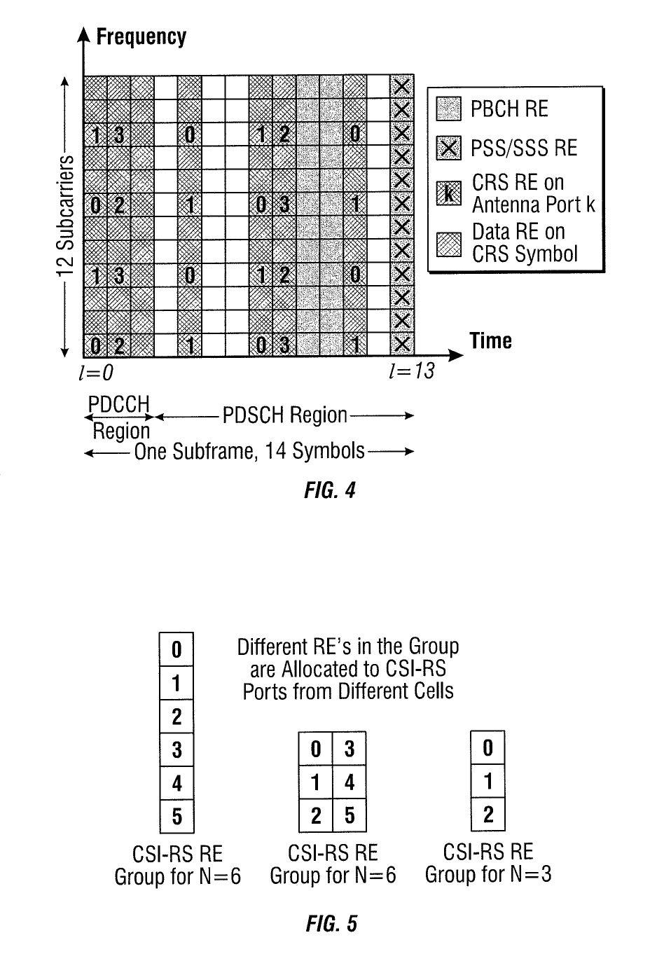

The potential collision with PSS/SSS/PBCH in FDD can happen in the six central PRBs in subframe #0 as shown in FIG. 4. FIG. 4 depicts a physical resource block in subframe #0 with CRS, SSS and PBCH in TDD, according to an embodiment. However, because subframe #0 is always a potential subframe carrying PCH, according to this embodiment, the CSI-RS may not be recommended to be sent in subframe #0 in TDD, for example.

Other non-MBSFN-capable subframes that allow CSI-RS transmission in Option-d can have the same resource availability as shown in FIG. 2, according to an embodiment.

According to the numbers and patterns of free REs available for CSI-RS transmission, these REs can be partitioned into groups containing an equal number (N) of REs. Each group can contain either N adjacent free REs or N disjointed free REs, and can hold a CSI-RS RE for one port per cell. Therefore, the maximal total number of groups, which is calculated as G_{MAX}=Z/N, may be no less than the total number of CSI-RS antenna ports per cell. Under the assumption that the cell identification (PCID) in LTE Rel-8 has a modulo-6 operation on CRS location differentiation and the usual cellular layout has three cells adjacent to each other, N can be 6 or 3, according to this exemplary embodiment.

Exemplary shapes and sizes of CSI-RS RE groups with N={3,6} adjacent REs are shown in FIG. 5. As depicted in FIG. 5, different REs in each group can be allocated to the CSI-RS ports from different cells.

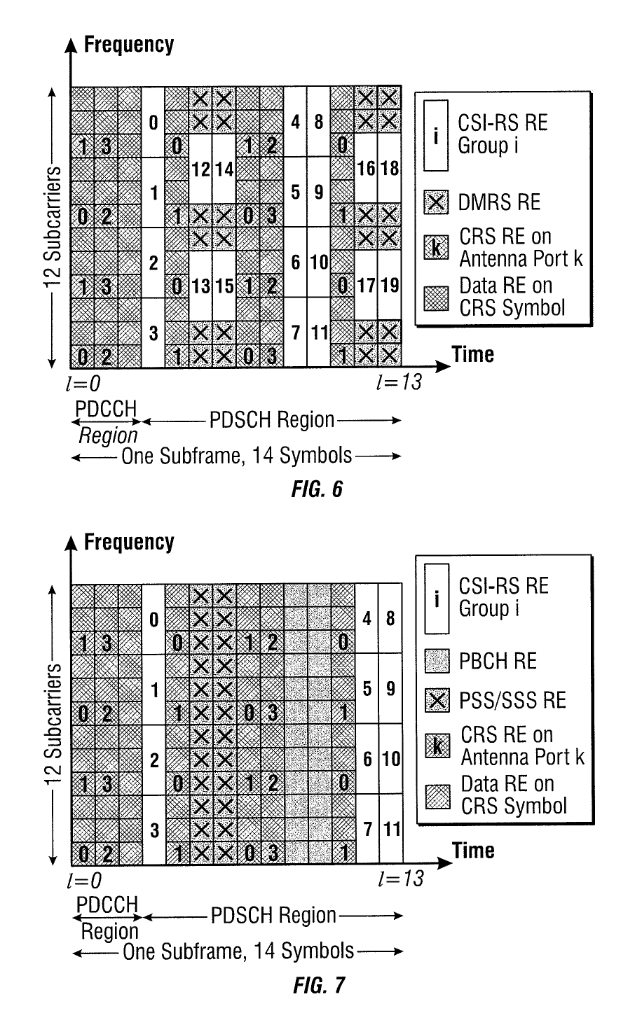

FIG. 6 depicts a physical resource block with CRS and DMRS for N=3, according to an embodiment. FIG. 7 depicts a physical resource block in subframe #0 with CRS, PSS/SSS and PBCH in FDD for N=3, according to an embodiment. As shown in FIG. 6 and FIG. 7, if N=3, every the adjacent REs can construct one CSI-RS RE group, for a regular non-MBSFN-capable subframe and subframe #0 in FDD, respectively.

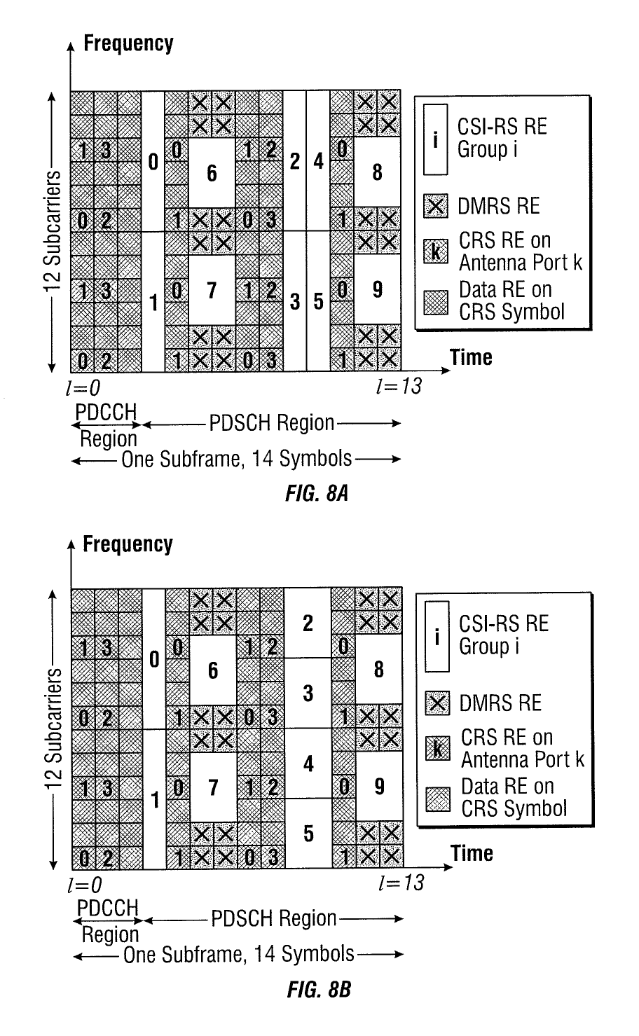

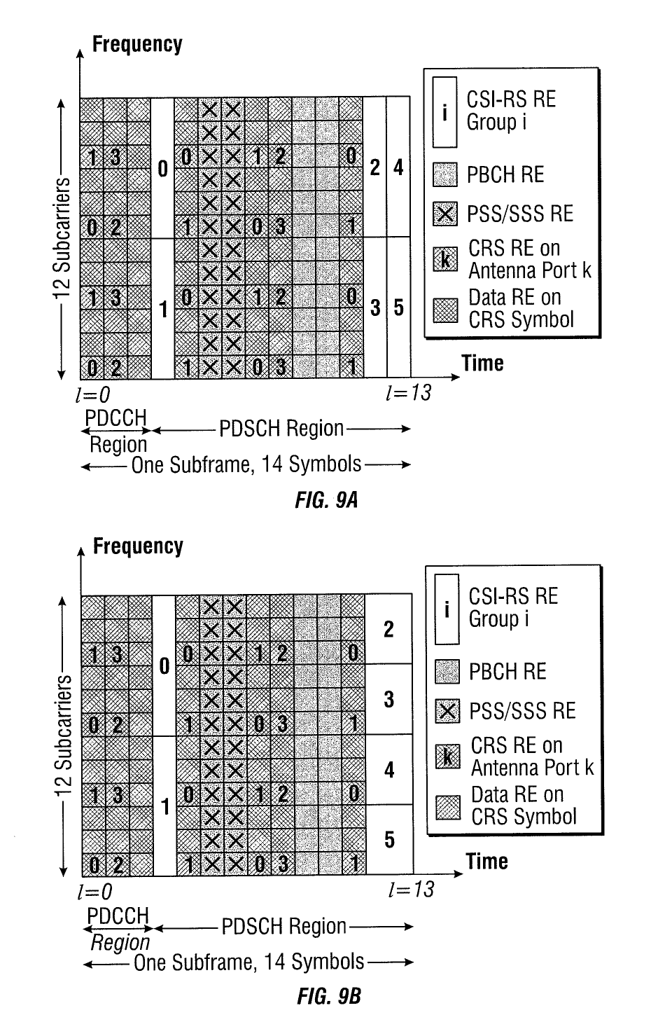

FIGS. 8A and 8B show exemplary options for allocation of physical resource blocks with CRS and DMRS for N=6, according to an embodiment. FIGS. 9A and 9B show exemplary options for allocation of physical resource blocks in subframe #0 with CRS, PSS/SSS and PBCH in FDD for N=6, according to an embodiment. As shown in FIGS. 8A-8B and FIGS. 9A-9B, if N=6, for example, every 6 adjacent REs can construct one CSI-RS RE group, for a regular non-MBSFN-capable subframe and subframe #0 in FDD, respectively. Moreover, there can be two options in defining six “adjacent” REs per group as shown in FIGS. 8A-8B and FIGS. 9A-9B, according to the exemplary embodiments.

Note that this disclosure does not restrict the value of N. Other values (such as 4, 8) are also within the scope of the present disclosure. Further, FIGS. 6-9 only show exemplary constructions of CSI-RS RE groups. It is noted that the N REs per group can be either adjacent to each other or disjointed from each other. The indices of a CSI-RS RE group also do not have to be in the order as shown in FIGS. 6-9, but the indexing may be the same across all PRB in the same type of subframe, for example.

In addition, not every CSI-RS RE group has to be used to carry a CSI-RS. The actual number of CSI-RS RE groups is denoted as G for G≦G_{MAX}. For example, the CSI-RS RE groups that share the same time symbols with DMRS might be unused for CSI-RS transmission, for example. In that case, the number of CSI-RS RE groups G can be equal to 36/N.

Assuming, for example, a DMRS RE may or may not be used together with a CSI-RS RE in the same symbol, and this is the only type of RE with such uncertainty. It also can be assumed that the CSI-RS supports CSI measurement on 8 antenna ports, according to the present embodiment. Then, the design parameters, G and N, can be obtained as in Table 2.

TABLE 2
Exemplary design parameters for CSI-RS RE allocation

| | Total number of | Design |
|---|---|---|
| | available RE per PRB | parameters |
| PRB types | for CSI-RS (Z) | <G, N> |
| Regular non-MBSFN-capable | 60 | <10, 6> or <8, 6> |
| subframe with CSI-RS and | | or <20, 3> |
| DMRS in the same symbol | | |
| Regular non-MBSFN-capable | 36 | <12, 3> |
| subframe with CSI-RS and | | |
| DMRS in different symbols | | |
| Subframe #0 in FDD | | |

Given G (i.e., the total number of CSI-RS RE groups available to CSI-RS) that has to satisfy G≧N_{ANT} (where N_{ANT} is the total number of CSI-RS antenna ports in a single cell) and N (i.e., the total number of available REs in each CSI-RS RE group), the k-th CSI-RS port (0≦k<N_{ANT}) in a cell whose cell identification is PCID is allocated to the j-th RE (0j≦N) in the i-th CSI-RS RE group of a total of G CSI-RS RE groups. Here, 0≦i<G is assumed. The mapping functions can be designed in such a way that:

For a mapping function of f: [symbol] k,PCID;G,N [symbol] →i, due to the fact that each cell has N_{ANT}≦G CSI-RS antenna ports, the function f should be able to:

map different <k PCID> with the same PCID to different i; and

map multiple <k, PCID> with different PCID to identical i and such mapping can be done uniformly, which could mean the mapping is pseudo-random.

A simple and straight-forward mapping structure is given by f(k,PCID;G,N)=[k+pseudo_random(PCID)] mod G, where mod represents a modulo operation, and pseudo_random(PCID) is any random number generation function with the generation seed equal to integer PCID.

For the mapping function of g: [symbol] k,PCID;G,N [symbol] →j, because each cell associated with one CSI-RS RE group can have only one CSI-RS RE in that group and it does not have to correspond to a specific CSI-RS port, index k can be removed from a function parameter list; meanwhile, it can be preferred to have as much inter-cell orthogonality as possible in each CSI-RS RE group, so the function g can map PCID evenly within N REs per CSI-RS RE group. One exemplary mapping function is given by g(PCID;G,N)=PCID mod N, where mod represents a modulo operation.

CSI-RS hopping can be applied to CSI-RS RE allocation, which means the CSI-RS RE for antenna port k of cell X can have different RE locations at different transmission time instances. Such hopping can be performed in units of one CSI-RS cycle or multiple CSI-RS cycles, for example, by either intra-group hopping or inter-group hopping or a combination of both.

For intra-group hopping, the mapping function f is not necessarily involved in the hopping process; mapping function g can take into account the time domain hopping instance, for example. For example, the modified function g with hopping is g(PCID,T;G,N)=(PCID+hop(T)) mod N, where hop(T) is a hopping function that converts the hopping time instance to an integer.

For inter-group hopping, the mapping function g is not necessarily involved in the hopping process; mapping function ƒ can take into account the time domain hopping instance. For example, the modified function ƒ with hopping is f(k,PCID,T;G,N)=[k+pseudo_random(PCID)+hop(T)] mod G, where hop(T) is a hopping function that converts the hopping time instance to an integer.

In certain implementation of the CSI-RS allocation methods described herein, the CSI-RS RE group may not be explicitly defined. The allocation of a CSI-RS RE for k-th antenna port of cell whose cell identification is PCID can be directly mapped to one RE in PRB. In this case, the concept of a CSI-RS RE could be referred to implicitly, and the target RE index among all available REs per PRB can be calculated as N*f(k,PCID;G,N)+g(PCID;G,N), for example.

In the examples shown in the figures described above, the CSI-RS RE group includes REs that are adjacent to each other. Nevertheless, embodiments of this disclosure allow the REs in each CSI-RS RE group to be separated apart in the PRB. From a mathematics point of view, there are various ways to index or order all the REs available to CSI-RS transmission in one PRB. For the same reason, the indexing of CSI-RS RE groups in PRB throughout FIGS. 5-8 are also for example purposes only, and not intended to limit the scope of the present disclosure. One of ordinary skill in the art would realize that different indexing and ordering methods may be utilized.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of allocating resource elements in an orthogonal frequency division multiplexing (OFDM) system for transmission of a channel state information reference signal (CSI-RS), comprising:
converting one or more resource elements to a two-dimensional frequency-time domain;
partitioning the one or more converted resource elements to units of a physical resource block (PRB);
determining whether at least a portion of a PRB is being used by a signal; and
allocating the at least a portion of the PRB for transmission of the CSI-RS, if the at least a portion of the PRB is not concurrently being used.

2. The method of claim 1, wherein the time-domain dimension of one PRB is one subframe.

3. The method of claim 1, further comprising:
transmitting the CSI-RS at resource element locations determined by the resource elements available to the CSI-RS in a regular downlink subframe, including at least one of a cell-specific reference signal (CRS), a physical downlink control channel (PDCCH) and a demodulation reference signal (DMRS).

4. The method of claim 1, further comprising:
transmitting the CSI-RS at resource element locations determined by the resource elements available to the CSI-RS in a frequency-division duplexing (FDD) downlink subframe including a CRS, a PDCCH, primary synchronization signal (PSS), secondary synchronization signal (SSS) and a DMRS.

5. The method of claim 3, further comprising:
transmitting the CSI-RS in a downlink subframe configured as a Multi-Media Broadcast over a Single Frequency Network (MBSFN) subframe.

6. The method of claim 3, further comprising:
transmitting the CSI-RS in a downlink subframe configured as a regular non-MBSFN subframe.

7. The method of claim 4, further comprising:
transmitting the CSI-RS in a downlink subframe configured as a MBSFN subframe.

8. The method of claim 4, further comprising:
transmitting the CSI-RS in a downlink subframe configured as a regular non-MBSFN subframe.

9. The method of claim 3, further comprising:
cancelling the transmitting over the entire bandwidth in a subframe where the CSI-RS collides with a resource element used by at least one of PSS, SSS, physical broadcast channel (PBCH), system information block type-1 (SIB1) and paging.

10. The method of claim 3, further comprising:
cancelling the transmitting of the CSI-RS on a specific resource element where the CSI-RS collides with a resource element used by at least one of PSS, SSS, and PBCH.

11. A station configured for allocating resource elements in an orthogonal frequency division multiplexing (OFDM) system for transmission of a channel state information reference signal (CSI-RS), comprising:
a conversion unit configured to convert one or more resource elements to a two-dimensional frequency-time domain;
a partitioning unit configured to partition the one or more converted resource elements to units of a physical resource block (PRB);
a determination unit configured to determine whether at least a portion of a PRB is being used by a signal; and
an allocation unit configured to allocate the at least a portion of the PRB for transmission of the CSI-RS, if the at least a portion of the PRB is not concurrently being used.

12. The station of claim 11, wherein the time-domain dimension of one PRB is one subframe.

13. The station of claim 11, further comprising:
a transmitter configured to transmit the CSI-RS at resource element locations determined by the resource elements available to the CSI-RS in a regular downlink subframe, including at least one of a cell-specific reference signal (CRS), a physical downlink control channel (PDCCH) and a demodulation reference signal (DMRS).

14. The station of claim 11, further comprising:
a transmitter configured to transmit the CSI-RS at resource element locations determined by the resource elements available to the CSI-RS in a frequency-division duplexing (FDD) downlink subframe including a CRS, a PDCCH, primary synchronization signal (PSS), secondary synchronization signal (SSS) and a DMRS.

15. The station of claim 13, further comprising:
a transmitter configured to transmit the CSI-RS in a downlink subframe configured as a Multi-Media Broadcast over a Single Frequency Network (MBSFN) subframe.

16. The station of claim 13, further comprising:
transmitting the CSI-RS in a downlink subframe configured as a regular non-MBSFN subframe.

17. The station of claim 14, further comprising:
a transmitter configured to transmit the CSI-RS in a downlink subframe configured as a MBSFN subframe.

18. The station of claim 14, further comprising:
a transmitter configured to transmit the CSI-RS in a downlink subframe configured as a regular non-MBSFN subframe.

19. The station of claim 13, further comprising:
a cancellation unit configured to cancel the transmitting over the entire bandwidth in a subframe where the CSI-RS collides with a resource element used by at least one of PSS, SSS, physical broadcast channel (PBCH), system information block type-1 (SIB1) and paging.

20. The station of claim 19, further comprising:
a cancellation unit configured to cancel the transmitting of the CSI-RS on a specific resource element where the CSI-RS collides with a resource element used by at least one of PSS, SSS, and PBCH.

21. The station of claim 11, wherein the station is a base station.

22. A non-transitory computer-readable recording medium storing thereon instructions for, when executed by a processor, performing a method of allocating resource elements in an orthogonal frequency division multiplexing (OFDM) system for transmission of a channel state information reference signal (CSI-RS), the method comprising:
converting one or more resource elements to a two-dimensional frequency-time domain;
partitioning the one or more converted resource elements to units of a physical resource block (PRB);
determining whether at least a portion of a PRB is being used by a signal; and
allocating the at least a portion of the PRB for transmission of the CSI-RS, if the at least a portion of the PRB is not concurrently being used.

23. The computer-readable recording medium of claim 22, wherein the time-domain dimension of one PRB is one subframe.

24. The computer-readable recording medium of claim 22, the method further comprising:
transmitting the CSI-RS at resource element locations determined by the resource elements available to the CSI-RS in a regular downlink subframe, including at least one of a cell-specific reference signal (CRS), a physical downlink control channel (PDCCH) and a demodulation reference signal (DMRS).

25. The computer-readable recording medium of claim 22, the method further comprising:
transmitting the CSI-RS at resource element locations determined by the resource elements available to the CSI-RS in a frequency-division duplexing (FDD) downlink subframe including a CRS, a PDCCH, primary synchronization signal (PSS), secondary synchronization signal (SSS) and a DMRS.

26. The computer-readable recording medium of claim 24, the method further comprising:
transmitting the CSI-RS in a downlink subframe configured as a Multi-Media Broadcast over a Single Frequency Network (MBSFN) subframe.

27. The computer-readable recording medium of claim 24, the method further comprising:
transmitting the CSI-RS in a downlink subframe configured as a regular non-MBSFN subframe.

28. The computer-readable recording medium of claim 25, the method further comprising:
transmitting the CSI-RS in a downlink subframe configured as a MBSFN subframe.

29. The computer-readable recording medium of claim 25, the method further comprising:
transmitting the CSI-RS in a downlink subframe configured as a regular non-MBSFN subframe.

30. The computer-readable recording medium of claim 24, the method further comprising:
cancelling the transmitting over the entire bandwidth in a subframe where the CSI-RS collides with a resource element used by at least one of PSS, SSS, physical broadcast channel (PBCH), system information block type-1 (SIB1) and paging.

31. The computer-readable recording medium of claim 30, the method further comprising:
cancelling the transmitting over of the CSI-RS on a specific resource element where the CSI-RS collides with a resource element used by at least one of PSS, SSS, PBCH, system SIB1 and paging.
